(19) United States
(12) Patent Application Publication
(10) Pub. No.: US 2013/0314527 A1
(43) Pub. Date: Nov. 28, 2013

(54) IMAGE PICKUP METHOD AND IMAGE PICKUP APPARATUS

(71) Applicant: Canon Kabushiki Kaisha, Tokyo (JP)

(72) Inventor: Miyoko Kawashima, Tokyo (JP)

(73) Assignee: Canon Kabushiki Kaisha, Tokyo (JP)

(21) Appl. No.: 13/900,093

(22) Filed: May 22, 2013

(30) Foreign Application Priority Data
May 28, 2012 (JP) 2012-120564

(51) Int. Cl. G02B 21/36

(52) U.S. Cl. CPC G02B 21/365
USPC 348/79

(57) ABSTRACT

An image pickup method includes dividing a surface shape of an object into a plurality of areas, approximating a surface of each of the plurality of areas to a plane, and calculating a slope of the plane, grouping the plurality of areas into m groups so that slopes of planes corresponding to the areas belonging to the same group fall within a permissible range, tilting a stage configured to hold the object so that all slopes of planes belonging to a group k of the m groups can fall within a depth of focus where k is an integer selected from 1 to m, making image sensors corresponding to the areas belonging to the group k among the plurality of image sensors, capture images of the object, and repeating tilting and caputing from k=1 to k=m.

### BACKGROUND OF THE INVENTION

1. Field of the Invention

The present invention relates to an image pickup method and image pickup apparatus configured to capture a microscope image of a sample.

2. Description of the Related Art

In the microscope system configured to capture a microscope image of a sample, focusing becomes difficult as a high resolution is promoted with a wide visual field because a depth of focus reduces. As a result, focusing upon the whole sample surface (or its parallel surface) becomes difficult due to the influences of uneven thicknesses and undulate surface shapes of the sample and the slide glass, and the heat generated in an optical system. Japanese Patent Laid-Open No. (“JP”) 2012-098351 proposes a method of moving an image sensor in an optical axis direction or of tilting the image sensor relative to the optical axis direction so as to focus a sample having undulation larger than a depth of focus upon an image plane throughout the visual field.

The space around the image sensor is limited by an electric circuit etc. When a plurality of image sensors are arranged in parallel and a mechanism of driving each image sensor in parallel to the optical axis direction, it is difficult to provide a tilting mechanism. Alternatively, even when the tilting mechanism can be provided, it is small and a tilt of the image sensor is limited.

### SUMMARY OF THE INVENTION

The present invention provides an image pickup method and image pickup apparatus configured to focus the whole surface of a wide sample upon an image plane with a high resolution.

An image pickup method according to the present invention is configured to capture an image of an object utilizing a plurality of image sensors. The image pickup method includes a step of dividing a surface shape of the object into a plurality of areas, a step of approximating a surface of each of the plurality of areas to a plane, and of calculating a slope of the plane, a grouping step of grouping the plurality of areas into m groups so that slopes of planes corresponding to the areas belonging to the same group fall within a permissible range, a tilting step of tilting a stage configured to hold the object so that all slopes of planes belonging to a group k of the m groups can fall within a depth of focus where k is an integer selected from 1 to m, an image pickup step of making the image sensors corresponding to the areas belonging to the group k among the plurality of image sensors, capture images of the object, and a step of repeating the tilting step and the image pickup step from k=1 to k=m.

Further features of the present invention will become apparent from the following description of exemplary embodiments with reference to the attached drawings.

### BRIEF DESCRIPTION OF THE DRAWINGS

FIG. 1 is a block diagram of a microscope system according to the first and second embodiments of the present invention.

FIGS. 2A, 2B, 2C, and 2D are schematic diagrams of an arrangement and a driving method of image sensors illustrated in FIG. 1 according to the first and second embodiments.

FIG. 3A is a flowchart for explaining an image pickup method executed by a controller illustrated in FIG. 1 according to the first and second embodiments.

FIG. 3B is a flowchart for explaining an example of S104, S106, and S107 illustrated in FIG. 3A according to the first embodiment.

FIG. 3C is a flowchart for explaining another example of S104, S106, and S107 illustrated in FIG. 3A according to the second embodiment.

FIG. 4 illustrates an undulate sample according to the first embodiment.

FIGS. 5A and 5B illustrate a visual field division and a plane approximation according to the first embodiment.

FIG. 6 illustrates one example of a slope distribution of a plane according to the first embodiment.

FIGS. 7A, 7B, 7C, 7D, and 7E illustrate a procedure of grouping of the slope distribution of the plane according to the first embodiment.

FIGS. 8A and 8B illustrate a slope distribution before and after the image sensor is tilted according to the second embodiment of the present invention.

### DESCRIPTION OF THE EMBODIMENTS

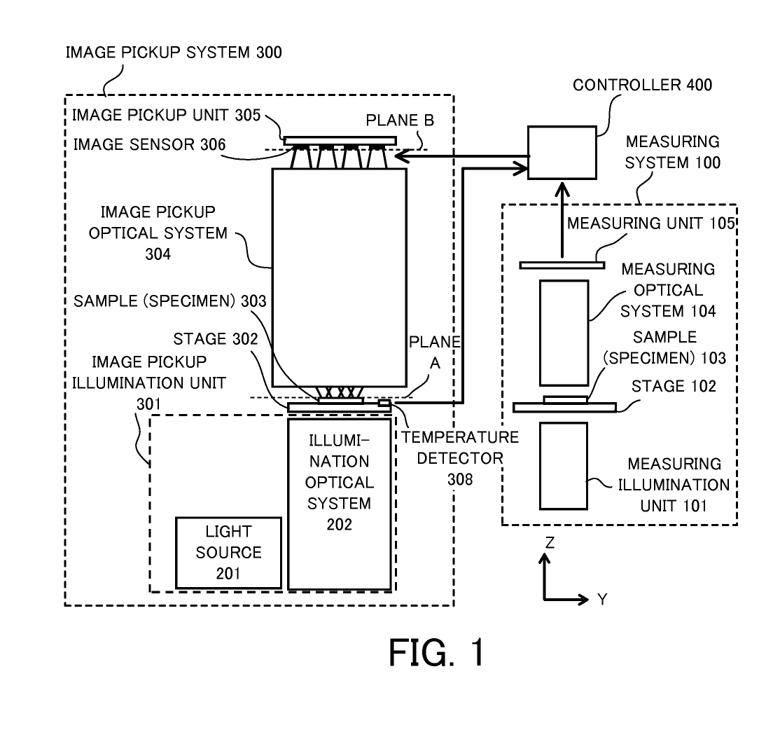

FIG. 1 is a block diagram of a microscope system according to this embodiment. The microscope system includes a measurement system (measurement apparatus) 100 configured to measure a shape of a sample, such as a human tissue fragment, or a thickness of a slide glass, and an image pickup system (image pickup apparatus) 300 configured to capture an image of the sample. A controller 400 is connected to both of the measurement system 100 and the image pickup system 300. The controller 400 may be provided to one of the measurement system 100 and the image pickup system 300, or it may be connected to both of them through a network and provided separately from them. The measurement system 100 may be part of the image pickup system 300.

The measurement system 100 includes a measuring illumination unit 101, a measuring stage 102, a measuring optical system 104, and a measuring unit 105.

The measuring illumination unit 101 includes an illumination optical system configured to illuminate a sample (specimen or object to be captured) 103 mounted onto the measuring stage 102 utilizing light from a light source. The measuring stage 102 holds the sample 103, and adjusts a position of the sample 103 relative to the measuring optical system 104. Thus, the measuring stage 102 is configured to move in the three-axis direction. In FIG. 1, the optical axis direction of the measuring illumination unit 101 (or measuring optical system 104) is set to a Z direction, the two directions orthogonal to the optical axis direction are set to an X direction (not illustrated) and a Y direction.

The sample 103 includes a target to be observed, such as a tissue section, placed on a slide glass, and a transparent protector (cover glass) configured to hold the slide glass and to protect the tissue fragment. The measuring unit 105 measures a size of the sample 103 and a surface shape of the transparent protector or the sample 103 by receiving light that has transmitted through or reflected on the measuring optical system 104.

The measuring optical system 104 may have a low resolution, or may use an image pickup optical system configured to widely capture an image of an entire tissue section. A size of the observation target contained in the sample can be calculated by a general method, such as a binarization and a contour detection, utilizing a brightness distribution of the sample image. A surface shape measuring method may measure the reflected light or utilize an interferometer. For example, there are an optical distance measuring method for utilizing a triangulation disclosed in JP 6-011341 and a method for measuring a difference of a distance of laser light reflected on a glass boundary surface utilizing a cofocal optical system disclosed in JP 2005-98833. The measuring optical system 104 serves to measure a thickness of the cover glass utilizing the laser interferometer. The measuring unit 105 transmits the measured data to the controller 400.

After a variety of physical amounts of the sample, are measured such as the size and shape of the sample, a sample carrier (not illustrated) is used to move the sample 103 mounted on the measuring stage 102 to the image pickup stage 302. For example, the measuring stage 102 itself may move and serve as the image pickup stage 302 or the sample carrier (not illustrated) grasps the sample 103 and moves to a position above the image pickup stage 302. The image pickup stage 302 is configured to move in two directions (X direction and Y direction) orthogonal to the optical axis (Z direction), and rotate around each axis.

The image pickup system 300 includes an image pickup illumination unit 301, the image pickup stage 302, an image pickup optical system 304, and an image pickup unit 305.

The image pickup illumination unit 301 includes an illumination optical system 202 configured to illuminate the sample 303 placed on the image pickup stage 302, utilizing light from the light source 201. The image pickup illumination unit 301 includes the light source 201 and the illumination optical system 202. The light source 201 may use, for example, a halogen lamp, a xenon lamp, or a light emitting diode (“LED”). The image pickup optical system 304 is an optical system configured to form an image of the sample illuminated on a surface A, on an image pickup plane B of the image sensor 306 at a wide angle of view and a high resolution.

The image pickup stage 302 holds the sample 303 and adjusts its position. The sample 303 is the sample 103 that has been moved from the measuring stage 102 to the image pickup stage 302 via the sample carrier (not illustrated). Different samples may be provided on the measuring stage 102 and on the image pickup stage 302. A temperature detector 308 may be arranged on the stage or in the stage near the sample, and measure the temperature near the sample. The temperature detector 308 may be arranged in the sample, for example, between the cover glass and the slide glass. It may be arranged in the image pickup optical system, or a plurality of temperature detectors may be arranged at both of them.

The image pickup unit 305 receives an optical image that is formed by the transmitting light or reflected light from the sample 303 via the image pickup optical system 304. The image pickup unit 305 has an image sensor 306, such as a charged coupled device (“CCD”) and a complementary metal oxide semiconductor (“CMOS”), on an electric substrate.

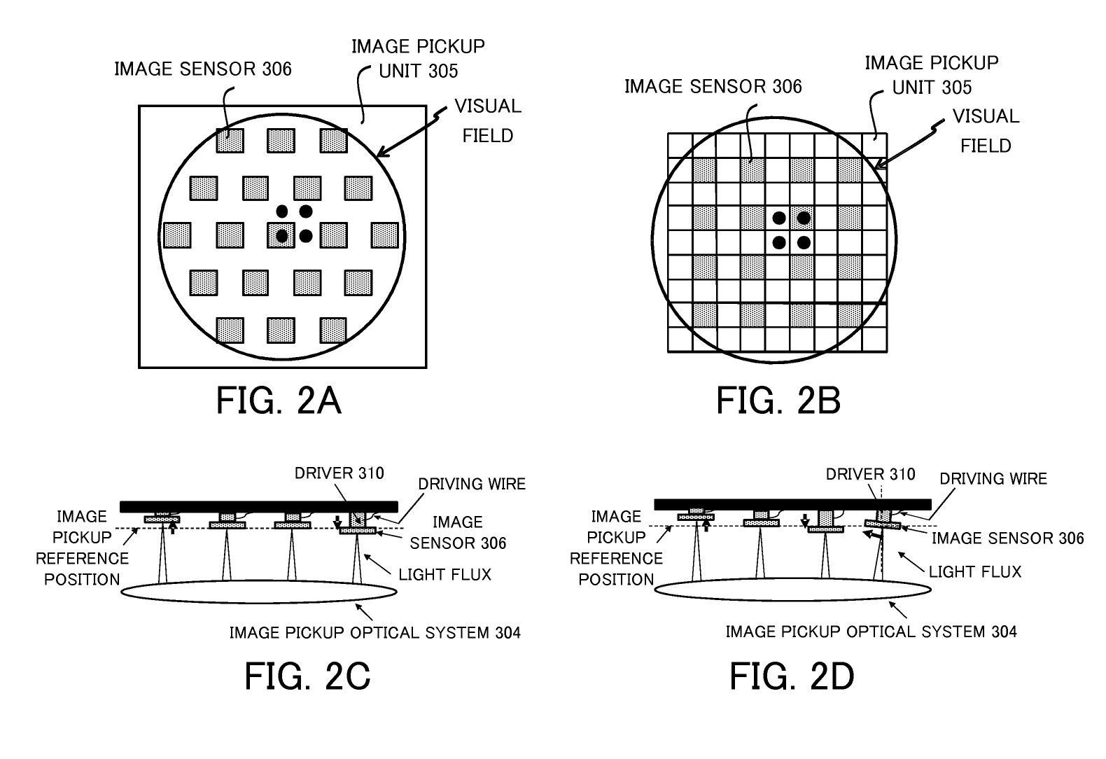

A plurality of image sensors 306 are provided in the visual field of the image pickup optical system 304. A light receiving plane of the image sensor 306 is configured to accord with the image plane of the image pickup optical system 304. As illustrated in FIGS. 2A and 2B, for example, the image sensors 306 are arranged and divide the visual field. These are plane views of the image pickup unit 305 viewed from the optical axis direction. The size of the image sensor 306 is not limited as illustrated, and usually the image sensors 306 are closely arranged on the image pickup plane. FIGS. 2C and 2D are plane views of the image pickup unit 305 viewed from the direction orthogonal to the optical axis. As illustrated in FIG. 2C, each image sensor 306 can be moved from an image pickup reference position in the optical axis direction. Moreover, as illustrated in FIG. 2D, each image sensor 306 can be tilted.

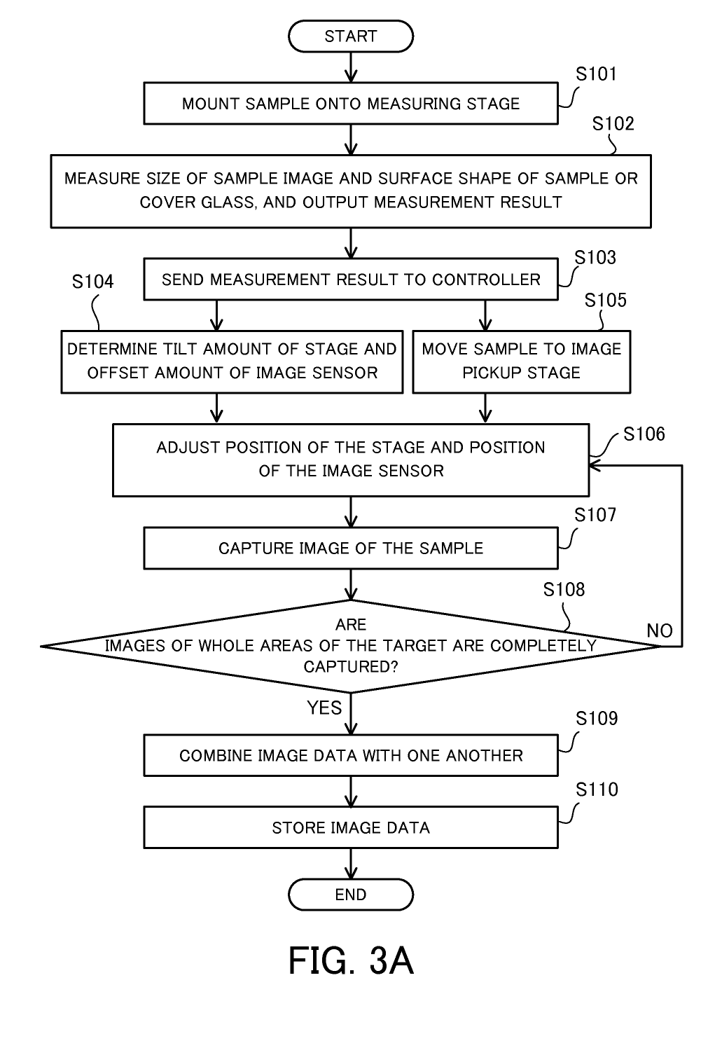

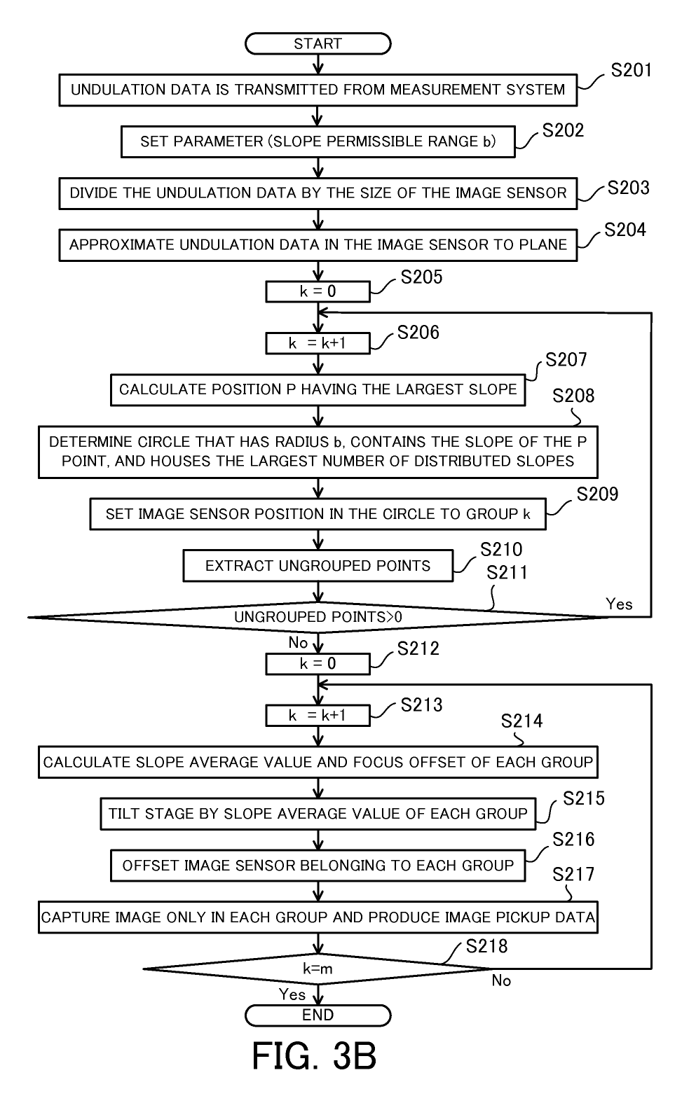

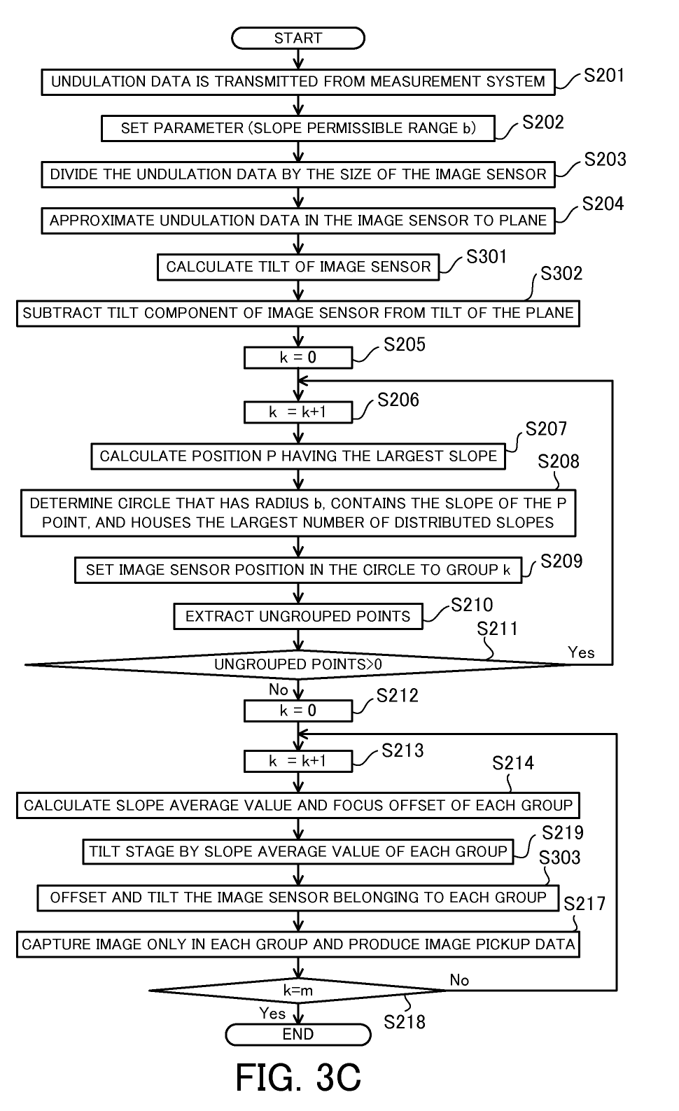

FIG. 3A is a flowchart of an image pickup method executed by the controller 400, and “S” stands for the “step.” The image pickup method can be implemented as a program that enables the controller 400 as a computer to execute each step.

Initially, the sample 103 is mounted onto the measuring stage 102 (S101). Next, the measuring illumination unit 101 illuminates the sample 103 on the measuring stage 102, and the measuring unit 105 receives the reflected light or transmitting light from the measuring optical system 104 and measures an intensity value of the reflected or transmitting light and a coordinate value in the depth direction (S102). Thereafter, the measured data is sent to the controller 400 (S103).

Next, the controller 400 determines a position correcting amount for the image pickup optical system 304 (S104). The controller 400 has a calculating function configured to calculate a relative image pickup position between the sample 303 and the image pickup optical system 304 from the measured surface shape of the sample 303 and other data, approximates the surface shape of the sample 303 to the least square plane, and calculates a center position of the least square plane, its defocus, and a tilt of the plane.

A defocus amount contains a thickness of a measured cover glass, a shift from a set value, and an uneven thickness of the slide glass. Alternatively, data of a focus shift factor, such as measured temperature data is transmitted to the controller 400, and the controller 400 calculates a generated focus shift amount based upon the data and may add it.

The controller 400 calculates tilt amounts of the image pickup stage 302 in the x and y directions based upon the determined correction position, and a moving amount of the image sensor 306 in the z direction. The mechanism of tilting the image sensor 306 may be also used, and the image sensors 306 may bear a partial burden of tilting in the x and y directions. In this case, the controller 400 calculates tilting amounts of the driver 310 for the image sensor 306 in the x and y directions, and tilting amounts of the image pickup stage 302 in the x and y directions.

While the correction aberration amount is calculated, the sample 103 is carried from the measuring stage 102 to the image pickup stage 302 via the sample carrier (not illustrated) (S105).

Thereafter, the driver 310 for the image sensor 306 and the image pickup stage 302 are driven based upon the signal transmitted from the controller 400. The image pickup stage 302 sets the sample position in the x and y directions to the image pickup position, and adjusts tilts relative to the x and y directions based upon the correcting amount instructed by the controller 400. At the same time, the z direction position of the image sensor 306 is adjusted (see FIG. 2C). When the driver 310 for the image sensor 306 serves to tilt it relative to the x and y direction, the tilted position is also adjusted (see FIG. 2D) (S106).

Next, the image pickup illumination unit 301 illuminates the sample 303 mounted on the image pickup stage 302, and the image pickup unit 305 captures an image of the transmitting light or reflected light from the sample 303 via the image pickup optical system 304. Thereafter, the image pickup unit 305 converts an optical image received by each image sensor 306 into an electric signal, and the image data is transmitted to an image processor (not illustrated). The image pickup data is transmitted to a storage unit inside or outside the image pickup apparatus and stored (S107).

S104, S106, and S107 will be explained in detail in the first and second embodiments.

Unless images of the entire area of the target are completely captured (No of S108), the tilt of the image pickup stage 302 is changed without changing relative positions in the x and y direction between the image pickup stage 302 and the sample 303, S106 and S107 are repeated, and image pickup data is obtained at the predetermined image pickup position.

Next, an image pickup position is shifted so as to fill the aperture among the image sensors 306, and a series of processes is performed so as to capture images. In addition, based upon the size information of the entire sample transmitted from the measuring unit 105, an image is captured by changing an image pickup visual field for the same sample so as to obtain an image of the entire sample. After the image is captured for the entire areas of the observation target (Yes of S108), all image pickup data is combined by the image processing (S109), image data of the sample over the wide area is obtained and stored in the storage unit (not illustrated) inside or outside the image pickup apparatus (S110). After a plurality of images are captured, a plurality of pieces of transmitted image data are combined by the image processor. In addition, image processing, such as a gamma correction, a noise reduction, a compression, etc. is performed.

### First Embodiment

FIG. 3B is a flowchart for explaining one example of S104, S106, and S107 illustrated in FIG. 3A according to the first embodiment.

In order to capture an image utilizing an optical system having a wide visual field at one time, the image sensors illustrated in FIGS. 2A and 2B are arranged so as to divide the visual field. Thereby, the image sensors 306 can be individually moved in the optical axis direction so as to accord a focus position with the imaging position. If the sample 303 has large undulation or the image sensor 306 is large, even when the center of the image sensor 306 is accorded with the focus position, the periphery becomes blurred. When the image sensor 306 is tilted, the entire image sensor 306 may be focused, but it is necessary to tilt it by a tilt of the sample times the magnification so as to correct the tilt of the image sensor 306. Since a length on the image plane in the direction orthogonal to the optical axis direction is multiplied by the magnification and a length on the image plane parallel to the optical axis is multiplied by a square of the magnification, the tilt is multiplied by (magnification)²/(magnification)=(magnification) times. For example, when the magnification is ten times, the size on the image plane has ten times of the lateral magnification, a hundred times of the longitudinal magnification, and ten times of the tilt. As the magnification increases, the image sensor 306 must be further tilted and the mechanism of tilting the image sensor 306 becomes larger.

Accordingly, this embodiment tilts the sample 303 rather than the image sensor 306. Since the sample cannot be partially tilted, the image pickup may be repeated by changing a tilt for each fragment. Nevertheless, when the image of the fragment is repeated, the image pickup takes a long time and an advantage of the wide visual field is lost. A description will be given of an example of a certain surface shape of the sample. Measurement data having a very large undulation is used for the example.

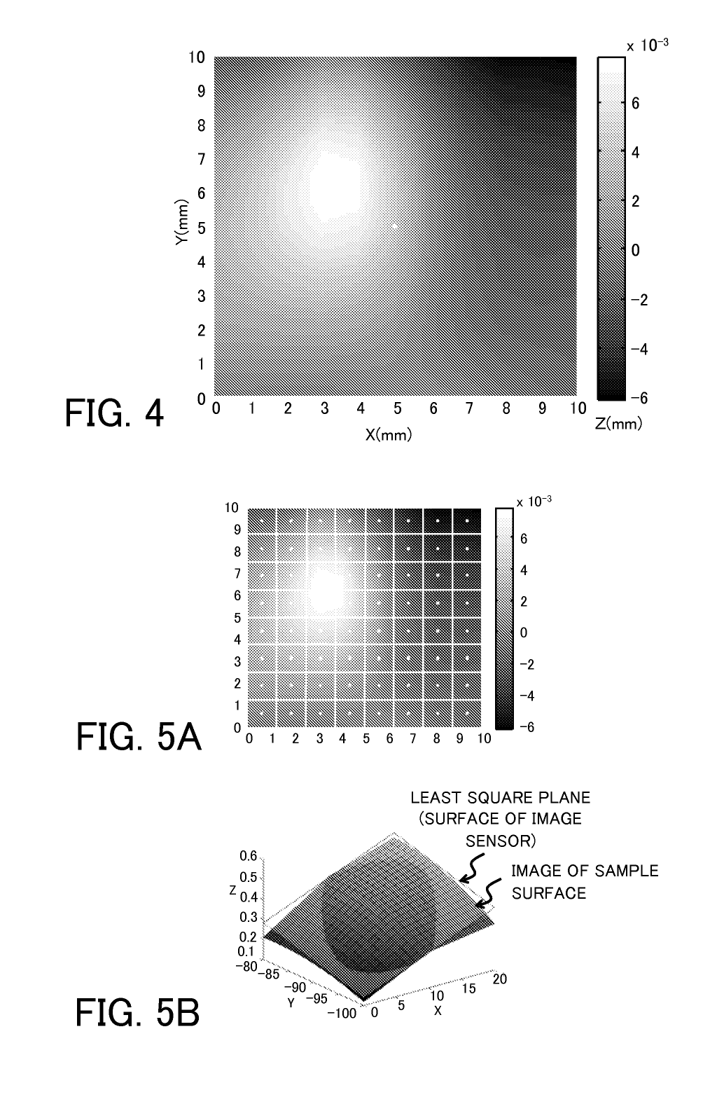

FIG. 4 is an illustrative surface map of the sample which is a distribution of the undulation of the sample surface. The horizontal direction is set to an x direction, the vertical direction is set to a y direction, and a length (mm unit) on the sample is illustrated. The optical axis direction is set to a z direction, and a scale bar in the figure corresponds to a length in the z direction illustrated by a length (mm unit) on the sample. It is understood that the sample plane has undulation of ±6 μm or larger. The surface shape (x, y, z) of the sample 103 is sent from the measurement system 100 to the controller 400 (S201).

Next, a slope permissible range b is set as a parameter. This is a permissible range of a tilt distribution of each plane in S204, which will be described later, by which the sample surface is divided, a plane is approximated for each divided surface, and a slope of each plane is calculated. This means a tilt correcting error when the tilt is corrected, and the slope permissible range is determined so that it can fall within a permissible focus error. In other words, the slope permissible range b is determined by the size of the image sensor 306 and the permissible focus error. The slope permissible range b depends upon a value made by dividing the permissible focus error by the size of the image sensor. The permissible focus error is determined by the depth of focus. The slope permissible range b may be set in advance or may be calculated by inputting the size of the image sensor 306, the permissible focus error or the wavelength of the light and the numerical aperture of the optical system used for the image pickup (S202).

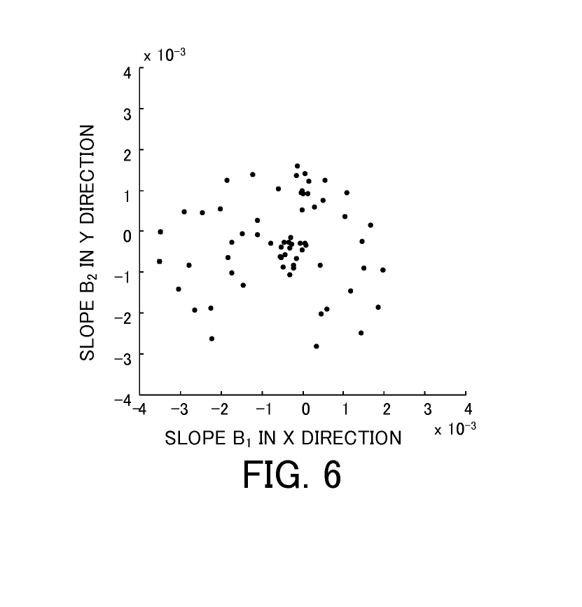

Next, the surface shape map of the sample 303 in the visual field is divided into a plurality of fragments (S203). Since the above slope is calculated on the sample, assume the scale of the surface shape map on the sample. Then, the size of the fragment is equal to the magnification-converted size of the image sensor 306 or the magnification-converted size of the image sensor 306 from which the overlapping area for connections is removed. In other words, the size of the fragment is equal to the size of the image sensor 306 divided by the magnification. The surface shape map is divided into the fragments, as illustrated in FIG. 5A. FIG. 5A illustrates dividing lines on the surface shape map illustrated in FIG. 4, and each illustrated white point denotes a divided center position. In this example, the visual field of the optical system has a square shape having 10 mm on one side on the sample side. The magnification is ten times, and the image sensor 306 has a square shape having 12.5 mm on one side. A length of one side of the image sensor 306 on the sample 303 is converted into 1.25 mm based upon the magnification, and the visual field is divided into eight both in the longitudinal and lateral directions. In other words, it is divided into 8×8=64 fragments.

Assume that the illustrative optical system uses light having a wavelength of 500 nm, a numerical aperture (NA) of 0.7, and a depth of focus of about 1 μm. When the permissible focus error is ±0.5 μm, one side of the fragment has a length of 1.25 mm, and a permissible tilt error becomes tan⁻¹(0.5×10⁻³/(1.25/2))=0.8×10⁻³ or about 1 mrad and thus b=1 (mrad). Assume that a surface shape map (xⱼ, yⱼ, zⱼ) is a z position of the surface relative to the sample point (xⱼ, yⱼ) in each divided fragment. Herein, the sample surface is approximated to a plane, and the plane is calculated by the least square method based upon the surface shape map. The plane is given as follows:

z=B₁x+B₂y+B₃ (1)

This plane is calculated for each divided fragment as follows where i denotes a fragment number (i=1˜n)

z=B₁(i)x+B₂(i)y+B₃(i)(i=1, . . . , n) (2)

Coefficients B₁(i), B₂(i), and B₃(i) are calculated for each of i=64 fragments. Since the tilt is small, B₁ and B₂ can be approximated to a slope in the x direction (first direction) and to a slope in the y direction (second direction), respectively. Thereby, the surface shape of each fragment can be approximated by a plane and a slope of the plane can be calculated. B₃ is a focus offset (S204). Herein, the group number k is set to k=0 (S205), and k is incremented by 1 (or k+1) as a next group is set (S206).

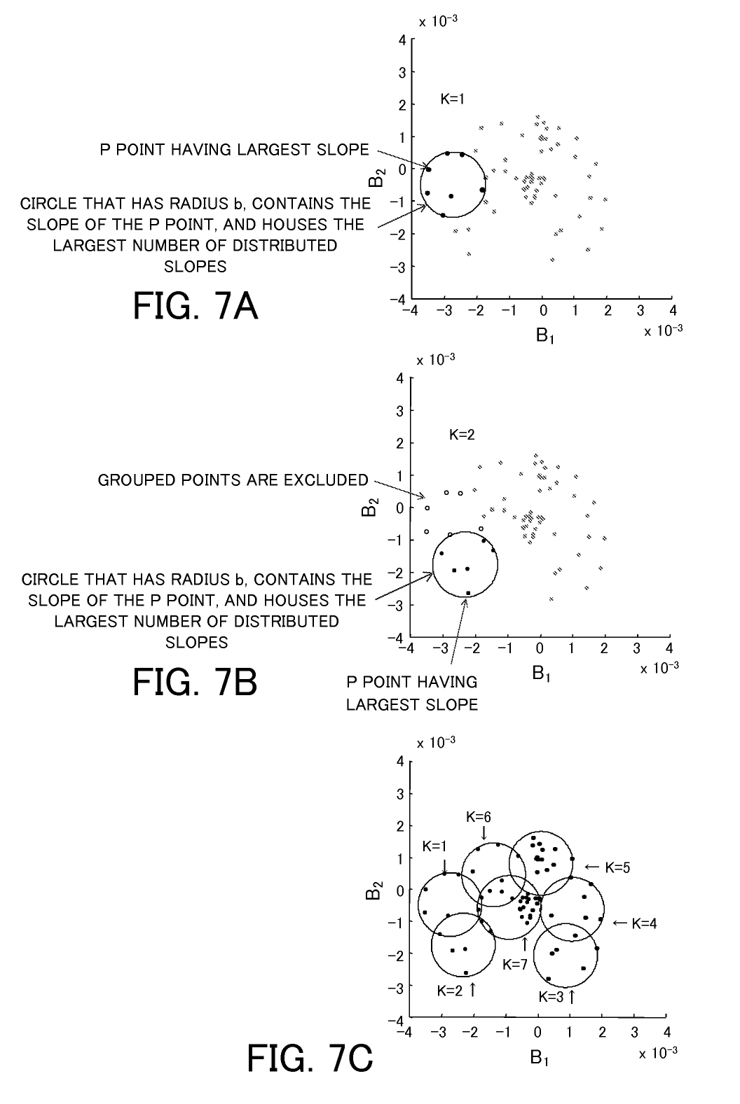

FIG. 5B is a three-dimensionally expressed plane, which is calculated by applying the least square method to one divided fragment on the undulate sample surface. The sample surface is expressed in a dark color and the plane is expressed in a light color. FIG. 6 is a graph of a distribution of 64 calculated slopes B₁ and B₂ of the planes. It illustrates a magnitude of the slope in the radius vector direction, and a slope direction in the radius vector rotating direction. The unit of the slope in FIG. 6 is expressed by rad.

Next, the maximum of the slopes of the entire plane corresponding to the fragment is calculated as (B₁(i)²+B₂(i)²)^{1/2} (S207). It is understood from FIG. 6 that the maximum slope value of the sample is about 4 mrad. In the slope distribution, let a point having the maximum slope value “P point”, and a circle which has the P point and the most number of points is obtained. The radius b of the circle is equal to the slope permissible range b set in S202 (S208).

The points contained in this circle are grouped into m groups k (k=1, 2, . . . , m) (S209). This grouping step produces m groups that include fragments in each of which a slope amount of the plane among a plurality of fragments falls within the permissible range.

Next, except for the grouped points, ungrouped points are extracted (S210). A similar procedure is repeated for the ungrouped points. The flow from S206 to S210 is repeated and m groups are produced until there are no ungrouped points (S211).

After grouping is completed, a set of distributed slopes contained in the overlapping part in grouping may belong to either group. This example re-groups the point of the overlapping part into a group having a larger group number. As the group number increases, the slope reduces and the frequency of the slope distribution usually increases. By re-grouping the point of the overlapping part in the group having a larger group number, the number of points can be reduced in the set belonging to the group having a smaller group number.

Alternatively, the set of the distributed slopes of the overlapping part as a result of grouping may belong to a group having a smaller group number. In either case, the focus residue is almost the same. The grouping method is not limited to the above method, and grouping may be made so that the group number m can be as small as possible or minimized. Grouping may start with part having a larger frequency of the distributed slopes.

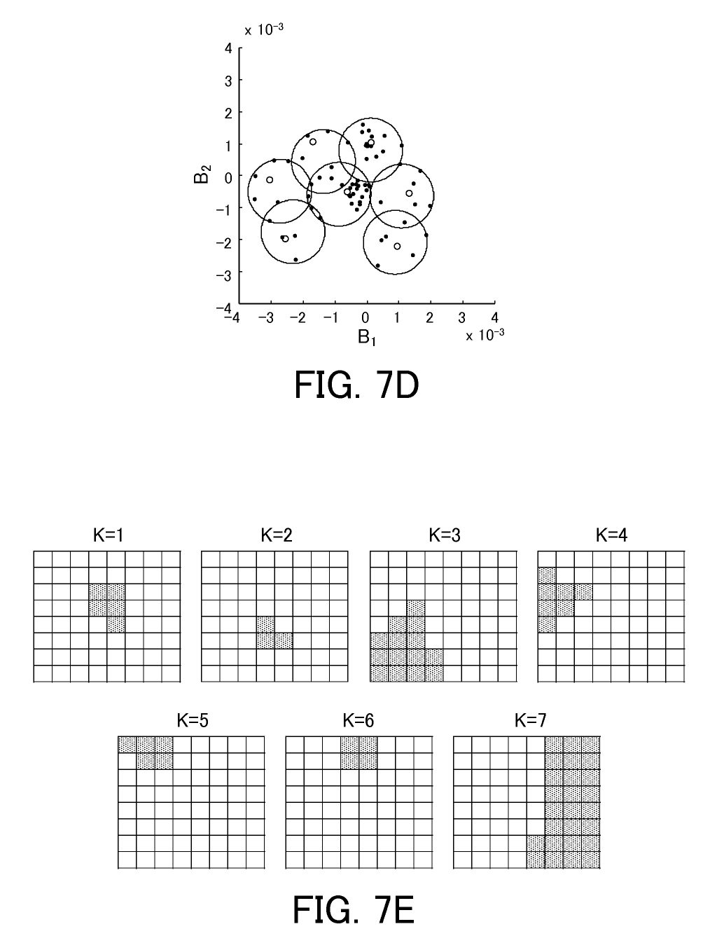

FIGS. 7A to 7C illustrate the above procedure example. In FIG. 7A, a P point is set to a point having the maximum slope, a circle having a radius b and containing the P point is set, and those points which are located inside the circle are classified into a group 1. A grouped point is illustrated by a black dot, and an ungrouped point is illustrated by a gray dot. FIG. 7B illustrates next grouping. In FIG. 7B, a white dot denotes a previously grouped point which is thus excluded in this grouping, a black dot denotes a point newly grouped as a group 2, and a gray dot denotes an ungrouped point. FIG. 7C illustrates all slopes are grouped into 7 groups. A black dot denotes a point belonging to a corresponding group. A point contained in the overlap part between two circles may belong to either group, and this embodiment classifies the point in the overlap part into the group having a larger group number. When the number of ungrouped points becomes zero, the flow moves to the next step.

The next step calculates slopes B₀₁(k) and B₀₂(k) that represent each group, such as an average value of the slopes of each group. B₀₁ denotes a slope in the x direction, and B₀₂ denotes a slope in the y direction. The group number k corresponds to the fragment number i. Assume that the fragment in which the image sensors 306 capture images is a plane that represents the group. Then, a surface shape map zⱼ′ is approximated for the sample point (xⱼ, yⱼ) by the Expression 1. There is an approximation error between the actual surface shape map zⱼ and the approximated surface shape map zⱼ′. This causes a focus error. The representative slope is determined so as to reduce the focus error in the plane for the image sensors 306. For example, a slope that minimizes the maximum value of the focus error for all sample points contained in one surface among the 64 image sensors 306, or a slope that minimizes a square sum of a deviation is calculated. The focus offset is changed by the Expression 1 because the slopes B₁(i) and B₂(i) of points belonging to each group are replaced with the representative slopes B₀₁(k) and B₀₂(k).

Next, a group number k is set to k=0 (S212), and an average value and an offset of slope average values of k=1, 2, . . . , m are calculated.

For the group k, k is set to k+1 and the following steps are sequentially performed (S213). An offset amount given to the image sensor 306 is the above value multiplied by a square of the magnification (S214). In other words, the focus offset amount f(i) is expressed by Expression (3) where B₀₁(k) and B₀₂(k) denote representative slopes that represent the slopes of the points in each group, β denotes the magnification, and the surface shape map has sample points j=1, . . . , nⱼ inside the fragment i. The focus offset amount is a shift amount of the image sensor 306 in the optical axis direction, and will be simply referred to as an offset amount hereinafter. This offset amount corresponds to β² times as large as the shift amount of the sample surface in the optical axis direction.

f(i)=β²Σⱼ(zⱼ−B₀₁(k)xⱼ−B₀₂(k)yⱼ)/nⱼ (3)

FIG. 7D illustrates the representative values of the slopes in each group in the above example, as white dots utilizing an average value. Next, the stage 302 is tilted by the representative tilts B₀₁(k) and B₀₂(k) of each group (S215). S215 is a tilting step of tilting the stage 302 mounted with the object 303 so that all tilt amounts in the plane belonging to the group k (k is an integer selected from 1 to m) in the m groups can fall within a depth of focus but the image sensors 306 may be further tilted, as described later. In other words, it is sufficient that the tilting step tilts the sample 303 and the image pickup plane B of the image sensor 306 relatively to each other.

Only the image sensors 306 in the same group are moves by an offset amount f(i) in the optical axis direction (S216). S215 and S216 may be executed in parallel. Only the image sensors 306 in the same group capture images and obtain image pickup data (S217). S217 is an image pickup step configured to instruct a plurality of image sensors corresponding to the fragment i belonging to the group k, to capture images of the sample 303.

FIG. 7E illustrates the image sensors 306 arranged parallel to each other in the visual field. Each grating denotes the image sensor 306. The gray part illustrates the image sensors 306 in the same group. The image sensors 306 belonging to the same group is driven by an offset amount in the optical axis direction.

For example, in the first image pickup, the image sensors 306 belonging to the group k=1 are driven in the optical axis direction by the offset amount, and the stage 302 is tilted by the representative slope of the group k=1. Thereafter, only the image sensors 306 belonging to the same group capture images and send image pickup data. A similar flow is repeated for each group up to the group k=7. In other words, the tilting step and the image pickup step are repeated from k=1 to k=m (S218). The images can be thereby captured while all imaging positions of the points on the sample surface can fall within the depth of focus of the image pickup optical system 304. This is an example of a very large undulation. When the undulation is small, only one group or only one image pickup can capture an image of the entire visual field.

Most undulations can be classified into a smaller number of groups of the slopes. As the magnitude of the undulation becomes larger, the number of groups increases, and the image pickup needs a longer time. However, it is clear that the time can be remarkably saved in comparison with a case where 64 areas are captured one by one, totally 64 times. As the image sensor 306 becomes smaller, the slope permissible range b can be made larger and the number of groups and the image pickup time can reduce.

### Second Embodiment

FIG. 3C is a flowchart for explaining another example of S104, S106, and S107 illustrated in FIG. 3A according to a second embodiment. The second embodiment utilizes the tilt of image sensor 306 as well as the tilt of stage 302 as illustrated in FIG. 2D. The tilt of image sensor 306 is magnification times as large as that of the sample 303. Therefore, as the magnification increases, it is necessary to considerably tilt the image sensor for a sample having a large undulation.

For example, assume that the magnification is 10 times, the undulate sample 303 illustrated in FIG. 4 has a maximum angle of about 4 mrad and the image sensor 306 needs to be tilted by 40 mrad. Hence, if the undulation is corrected only by tilting the image sensor 306, the driver 310 for the image sensor 306 becomes larger and it becomes difficult to closely arrange a plurality of image sensors 306. On the other hand, as the driver 310 for the image sensor 306 becomes small, the image sensor 306 can be tilted little although a plurality of image sensors 306 can be closely arranged. Accordingly, the stage 302 is tilted so as to supplement the insufficient tilt of the image sensor 306.

For instance, when the driver 310 for the image sensor 306 is made compact so as to provide a tilt of 15 mrad, the image sensor 306 is titled for focusing for a tilt of 15 mrad or smaller. For a tilt larger than 15 mrad, the stage 302 is tilted by a necessary slope subtracted by 1.5 mrad. In other words, the following expressions are established for slopes B_{S1}(i) and B_{S2}(i) of the image sensor 306 for the fragment i where α (>0) is a driving range on the sample of the image sensor:

If(B₁(i))²+(B₂(i))²≦(α)², then B_{S1}(i)=B₁(i)·β and B_{S2}(i)=B₂(i)·β

If(B₁(i))²+(B₂(i))²>(α)², then B_{S1}(i)=α·cos θ(i)·β and B_{S2}(i)=α·sin θ(i)·β (4)

The slopes B_{S1} and B_{S2} of the image sensor 306 are angles necessary for the tilt correction and they are slopes in the x direction and in the y direction, respectively. New slopes B₁′ and B₂′ are given by the next expressions:

B₁(i)′=B₁(i)−α·cos θ(i) although B₁(i)′=0 if (B₁(i))²+(B₂(i))²≦(α)²

B₂(i)′=B₂(i)−α·sin θ(i) although B₂(i)′=0 if (B₁(i))²+(B₂(i))²≦(α)² (5)

Herein, θ denotes a slope direction and a denotes a preset coefficient in view of the specification of the image pickup apparatus. The new slopes B₁′ and B₂′ are angles necessary for the tilt correction by the stage, and they are slopes in the x direction and in the y direction, respectively.

A description will be given of the procedure with reference to the flowchart illustrated in FIG. 3C. S301˜S303 are added to FIG. 3B, and those steps in FIG. 3C which are corresponding steps in FIG. 3B are designated by the same reference numerals. The description utilizing an example of the same sample 303 as that of the first embodiment. After S204, the slopes B_{S1} and B_{S2} of the image sensor 306 are calculated in accordance with the Expression 3 (S301), and new slopes B₁′ and B₂′ are calculated as a supplement of the tilt of the image sensor 306 in accordance with the Expressions 4 (S302).

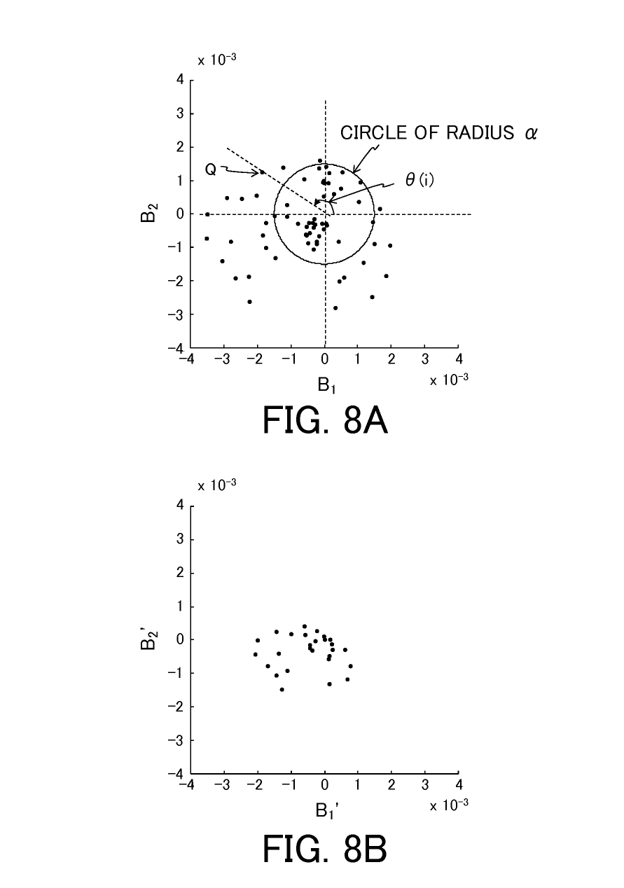

Referring to FIG. 8A, a description will be given of the processing of S302. FIG. 8A illustrates a slope distribution calculated by S204, and a tilt range α of the image sensor 306 in the tilt direction θ(i) at an arbitrary point Q in the illustrated fragment i. As illustrated in FIG. 8A, an x direction component of α from B₁ and a y direction component of α from B₂ are subtracted from a tilt larger than α. It is zero for a tilt equal to or smaller than α. Then, new slopes B₁′ and B₂′ form a slope distribution as in FIG. 8B. New slopes B1′ and B2′ are grouped by the flow from S205 to S208 similar to the method of the first embodiment and the slopes B₀₁ and B₀₂ of the stage of each group are calculated. Then, similar to the first embodiment, the stage tilt amount of each group and the focus offset amount of the image sensor 306 belonging to the same group are calculated (S214).

The focus offset amount f(i) in the fragment i belonging to the group k is calculated as follows based upon the tilt of the stage, the tilt of the image sensor 306, and the sample points j=1, . . . , nⱼ:

f(i)=β²Σⱼ{zⱼ−(B₀₁(k)+B_{S1}(i)/β)xⱼ−(B₀₂(k)+B_{S2}(i)/β)yⱼ}/nⱼ (6)

The stage 302 is tilted with the slopes B₀₁ and B₀₂ which represent the group (S219). Only the image sensor 306 belonging to the same group is moved by the offset amount of the image sensor 306 in the optical axis direction and tilted by the slopes Bₛ₁ and Bₛ₂ of the image sensor 306 (S303). S219 and S303, whichever may be performed first or both steps may be simultaneously performed. Next, only the image sensors 306 in the same group capture images and obtain image pickup data (S217).

This method can reduce the number of groups, and quickly capture an image while the imaging position can fall within the depth of focus of the image sensor 306 for all points on the surface of the sample 303.

One modification provides grouping without considering the slopes of the image sensors 306 utilizing the method of the first embodiment, and then subtracts the slopes of the image sensors in the fragment belonging to the same group. The slope of the image sensor 306 can be calculated in accordance with the Expression 3, and the slope of the stage 302 can be calculated in accordance with the Expression 4. In this case, the same result can be obtained by setting it larger than the slope permissible range b.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-120564, filed May 28, 2012, which is hereby incorporated by reference herein in its entirety.

What is claimed is:

1. An image pickup method configured to capture an image of an object utilizing a plurality of image sensors, the image pickup method comprising:
a step of dividing a surface shape of the object into a plurality of areas;
a step of approximating a surface of each of the plurality of areas to a plane, and of calculating a slope of the plane;
a grouping step of grouping the plurality of areas into m groups so that slopes of planes corresponding to the areas belonging to the same group fall within a permissible range;
a tilting step of tilting a stage configured to hold the object so that all slopes of planes belonging to a group k of the m groups can fall within a depth of focus where k is an integer selected from 1 to m;
an image pickup step of making the image sensors corresponding to the areas belonging to the group k among the plurality of image sensors, capture images of the object; and
a step of repeating the tilting step and the image pickup step from k=1 to k=m.

2. The image pickup method according to claim 1, wherein each of the plurality of areas corresponds to a size of an image pickup plane of each of the plurality of image sensors, which size is converted by a magnification of an image pickup optical system configured to form an image of the object on the image pickup plane of each image sensor.

3. The image pickup method according to claim 1, wherein first and second directions are orthogonal to an optical axis of an image pickup optical system configured to capture an image of the object on an image pickup plane of each of the plurality of image sensors, and the slope of the plane is expressed by a slope in the first direction and a slope in the second direction, and one group contains points in a circle having a radius b for the grouping step.

4. The image pickup method according to claim 3, wherein the radius b is determined by a permissible focus error, a size of each image sensor, and a magnification of an image pickup optical system configured to form an image of the object on an image pickup plane of each image sensor.

5. The image pickup method according to claim 1, further comprising a step of moving the image sensor belonging to the group k, by a focus offset mount in an optical axis direction of the image pickup optical system configured to form an image of the object on an image pickup plane of each image sensor.

6. The image pickup method according to claim 5, wherein the focus offset amount is an amount determined based upon the planes belonging to the group k.

7. The image pickup method according to claim 1, wherein the tilting step further tilts the image sensors belonging to the group k.

8. The image pickup method according to claim 1, further comprising the step of obtaining the surface shape of the object using a measurement apparatus.

9. The image pickup method according to claim 1, wherein the slopes tilted by the tilting step is determined by an average value or a weighted average value of all slopes of the planes belonging to the group k.

10. A non-transitory recording medium configured to store a program that enables a computer to serve to:
divide a surface shape of the object into a plurality of areas;
approximate a surface of each of the plurality of areas to a plane, and calculate a slope of the plane;
group the plurality of areas into m groups so that slopes of planes corresponding to the areas belonging to the same group fall within a permissible range;
tilt a stage configured to hold the object so that all slopes of planes belonging to a group k of the m groups can fall within a depth of focus where k is an integer selected from 1 to m;
make the image sensors corresponding to the areas belonging to the group k among the plurality of image sensors, capture images of the object; and
repeat the tilting step and the image pickup step from k=1 to k=m.

11. An image pickup apparatus comprising:
a stage configured to hold an object;
a plurality of image sensors each configured to capture an image of the object; and
a controller configured to control driving of the stage and capturing of each image sensor,
wherein the controller divides a surface shape of the object into a plurality of areas, approximates a surface of each of the plurality of areas to a plane, and calculates a slope of the plane, groups the plurality of areas into m groups so that slopes of planes corresponding to the areas belonging to the same group fall within a permissible range, tilts a stage configured to hold the object so that all slopes of planes belonging to a group k of the m groups can fall within a depth of focus where k is an integer selected from 1 to m, makes the image sensors corresponding to the areas belonging to the group k among the plurality of image sensors, capture images of the object, and repeats the tilting step and the image pickup step from k=1 to k=m.

12. The image pickup apparatus according to claim 11, wherein the controller further tilts the image sensors corresponding to the group k in the m groups and the stage so that the all slopes of the plane belonging to the group k can fall within a depth of focus.

13. The image pickup apparatus according to claim 11, further comprising a measurement apparatus configured to measure a surface shape of the object.
